(19) United States
(12) Patent Application Publication
(10) Pub. No.: US 2018/0073219 A1
(43) Pub. Date: Mar. 15, 2018

(54) HYDRAULIC APPARATUS OF CONSTRUCTION EQUIPMENT AND CONTROL METHOD THEREFOR

(71) Applicant: VOLVO CONSTRUCTION EQUIPMENT AB, Eskilstuna (SE)

(72) Inventors: Hyung-Seok PARK, Gyeongsangnam-do (KR); Jae-Hoon LEE, Gyeongsangnam-do (KR); Sang-Hee LEE, Gyeongsangnam-do (KR)

(73) Assignee: VOLVO CONSTRUCTION EQUIPMENT AB, Eskilstuna (SE)

(21) Appl. No.: 15/561,036

(22) PCT Filed: Apr. 13, 2015
(86) PCT No.: PCT/KR2015/003665

§ 371 Date: Sep. 23, 2017

(51) Int. Cl. E02F 9/14; E02F 9/20; E02F 9/22; F15B 13/02

(52) U.S. Cl. CPC E02F 9/14; E02F 9/2037; E02F 9/2228; F02D 29/04; F15B 13/021; E02F 9/2285; E02F 9/2296

(57) ABSTRACT

A hydraulic apparatus of construction equipment for increasing a fluid amount supplied to a small chamber of a boom cylinder in a jack-up operation and a control method therefor are provided. The hydraulic apparatus of construction equipment includes: a variable displacement hydraulic pump; a boom cylinder driven by a hydraulic fluid of the hydraulic pump; a boom manipulation lever; a boom control valve controlling a flow direction of the hydraulic fluid supplied to the boom cylinder; a first pressure sensor detecting a pilot pressure applied to the boom control valve; a second pressure sensor detecting a pressure of the hydraulic fluid supplied to the boom cylinder; and a controller increasing a fluid amount supplied to a small chamber of the boom cylinder by a preset amount when a pressure value of the hydraulic fluid supplied to the small chamber is equal to or greater than a preset value.

### BACKGROUND AND SUMMARY

The present invention relates to a hydraulic apparatus for construction equipment. More particularly, the present invention relates to a hydraulic apparatus for construction equipment for increasing a flow rate supplied to a small chamber of a boom cylinder when performing a jack-up operation, and a method therefor.

In general, a jack-up operation refers to lifting up a vehicle body of an excavator to perform an inspection or to repair a lower part of the excavator. In order to perform the jack-up operation of the excavator, a boom is descended by a retraction operation of a boom cylinder while a bucket is fixed on the ground, then the front part of the vehicle body of the excavator is lifted up based on the bucket.

When a self-load is used while descending a weighted body of a work implement which is configured with a boom, an arm, and a bucket of an excavator, fuel efficiency is improved by minimizing a flow rate supplied to a small chamber of the boom cylinder.

The self-load may be used for descending the work implement when performing a loading operation using an excavator. However, the self-load is not used when the work implement is descended for the jack-up operation. Accordingly, performance of the jack-up operation is degraded when the flow rate supplied to the small chamber of the boom cylinder is minimized when performing the jack-up operation.

Accordingly, the present invention has been made keeping in mind the above problems occurring in the related art, and the present invention is intended to propose a hydraulic apparatus for construction equipment for increasing a flow rate supplied to a small chamber of a boom cylinder when performing a jack-up operation, and a control method therefor.

According to an aspect of the present disclosure, there is provided a hydraulic apparatus for construction equipment, including:

a variable displacement hydraulic pump and a pilot pump;

a boom cylinder driven by a hydraulic fluid of the hydraulic pump;

a boom manipulation lever outputting a manipulation signal corresponding to a manipulation amount;

a boom control valve provided in a flow path between the hydraulic pump and the boom cylinder, and controlling a flow direction of the hydraulic fluid supplied to the boom cylinder when the control valve is operated;

a first pressure sensor detecting a boom-down or boom-up pilot pressure applied to the boom control valve;

a second pressure sensor detecting a pressure of the hydraulic fluid supplied from the hydraulic pump to a small chamber or large chamber of the boom cylinder; and

a controller increasing a flow rate supplied from the hydraulic pump to the small chamber of the boom cylinder by a preset amount when signals detected by the first and second pressure sensors designate an input of a boom-down manipulation signal, and a hydraulic fluid pressure value supplied to the small chamber of the boom cylinder is equal to or greater than a preset value.

According to another aspect of the present invention,

there is provided a control method of a hydraulic apparatus for construction equipment, wherein the hydraulic apparatus includes: a variable displacement hydraulic pump; a boom cylinder driven by a hydraulic fluid of the hydraulic pump; a boom manipulation lever; a boom control valve controlling a flow direction of the hydraulic fluid supplied to the boom cylinder; a first pressure sensor detecting a boom-down or boom-up pilot pressure applied to the boom control valve; a second pressure sensor detecting a pressure of the hydraulic fluid supplied to the boom cylinder; and a controller to which signals detected by the first and second pressure sensors are input, the method including:

receiving an input of a boom-down manipulation signal by the detected signal of the first pressure sensor;

determining whether or not a hydraulic fluid pressure value supplied to the small chamber of the boom cylinder is equal to or greater than a preset value by using the detected signal of the second pressure sensor; and

increasing a flow rate supplied from the hydraulic pump to the small chamber of the boom cylinder by a preset amount when detected signals of the first and second pressure sensors designate an input of the boom-down manipulation signal, and the hydraulic fluid pressure value supplied to the small chamber of the boom cylinder is equal to or greater than the preset value;

determining whether or not the boom-down manipulation signal is input, whether or not the hydraulic fluid pressure value supplied to the small chamber of the boom cylinder is less than the preset value, and whether or not a manipulation signal of a control valve for another work implement provided in an MCV block in which the boom control valve is provided is input; and

changing the flow rate supplied from the hydraulic pump to the small chamber of the boom cylinder to an initial preset value when at least any one of the following cases is satisfied: when the boom-down manipulation signal by the detected signals of the first and second pressure sensors is not input; when the hydraulic fluid pressure value supplied to the small chamber of the boom cylinder is less than the preset value; and when the manipulation signal of the control valve for another work implement provided in the MCV block in which the boom control valve is provided is input.

According to an aspect of the present invention including the above configuration, there is an effect on improving manipulability for a jack-up operation by increasing a flow rate supplied from a hydraulic pump to a boom cylinder when descending a work implement for performing the jack-up operation. In addition, fuel efficiency is improved by decreasing a flow rate supplied to the boom cylinder when descending the work implement except for performing the jack-up operation.

### BRIEF DESCRIPTION OF DRAWINGS

FIG. 1 is a hydraulic circuit diagram of a hydraulic apparatus for construction equipment according to an embodiment of the present invention.

FIG. 2 is a flowchart of a control method of the hydraulic apparatus for construction equipment according to the embodiment of the present invention.

### DESCRIPTION OF THE REFERENCE NUMERALS IN THE DRAWINGS

10; engine
11; variable displacement hydraulic pump
12; pilot pump
13; boom cylinder
14; boom manipulation lever
15; boom control valve
16; first pressure sensor
17; second pressure sensor
18; controller

### DETAILED DESCRIPTION

Hereinafter, a hydraulic apparatus for construction equipment, and a control method therefor according to a preferred embodiment of the present invention will be described in detail with reference to the accompanying drawings.

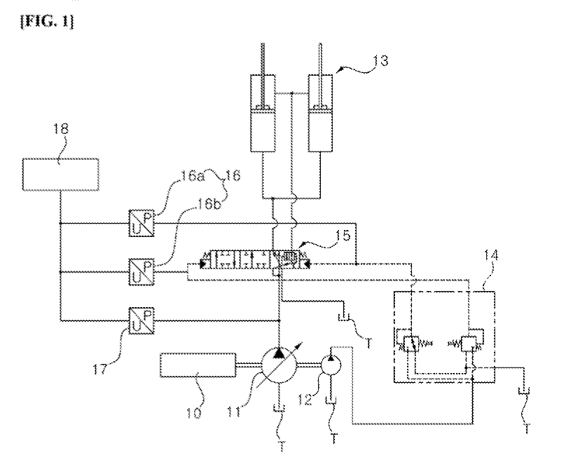

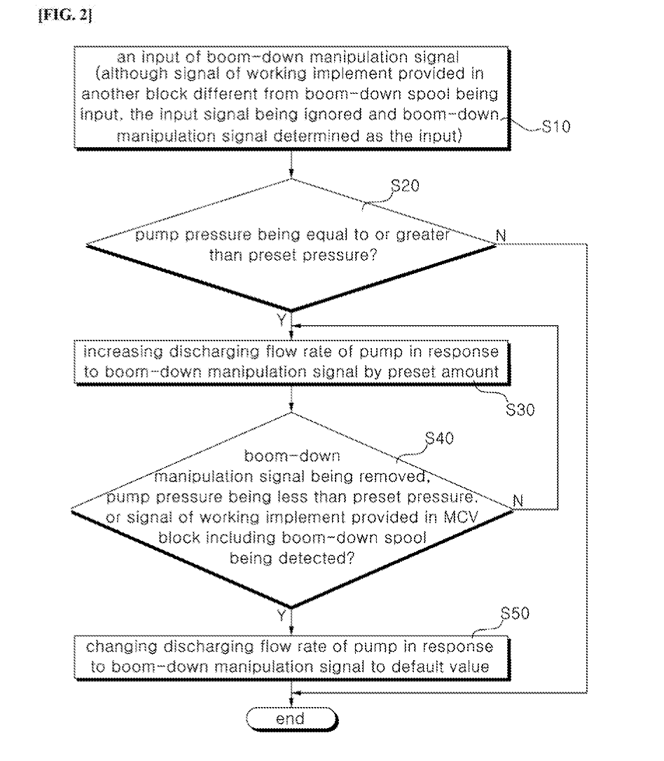

FIG. 1 is a hydraulic circuit diagram of a hydraulic apparatus for construction equipment according to an embodiment of the present invention, and FIG. 2 is a flowchart of a control method of the hydraulic apparatus for construction equipment according to the embodiment of the present invention.

Referring to FIG. 1 and FIG. 2, in the hydraulic apparatus for construction equipment according to the embodiment of the present invention,

a variable displacement hydraulic pump 11 (hereinafter, referred as a hydraulic pump) and a pilot pump 12 are connected to an engine 10.

A boom cylinder 13 performing a boom-up or boom-down is connected to the hydraulic pump 11.

A boom control valve 15 (main control valve (MCV)) that controls a flow direction of a hydraulic fluid supplied to the boom cylinder 13 is provided in a flow path between the hydraulic pump 11 and the boom cylinder 13.

A boom manipulation lever 14 (remote control valve (RCV)) that outputs a manipulation signal corresponding to a manipulation amount is provided in a flow path between the pilot pump 12 and the boom control valve 15.

A first pressure sensor 16 (16a and 16b) that detects a boom-down or boom-up pilot pressure applied to the boom control valve 15 is provided in a flow path between the boom manipulation lever 14 and the boom control valve 15.

A second pressure sensor 17 that detects a pressure of the hydraulic fluid supplied from the hydraulic pump 11 to a small chamber or large chamber of the boom cylinder 13 is provided in a flow path between the hydraulic pump 11 and the boom control valve 15.

A controller 18 increases a flow rate that is supplied from the hydraulic pump 11 to the small chamber of the boom cylinder 13 by a preset amount when signals detected by the first and second pressure sensors 16 and 17 designate an input of a boom-down manipulation signal, and a hydraulic fluid pressure value supplied to the small chamber of the boom cylinder 13 is equal to or greater than a preset value.

The controller 18 changes the flow rate supplied from the hydraulic pump 11 to the small chamber of the boom cylinder 13 to an initial preset value (default) when at least any one of the following cases is satisfied: when the boom-down manipulation signal by the detected signals from the first and second pressure sensors 16 and 17 is not input; when the hydraulic fluid pressure value supplied to the small chamber of the boom cylinder is less than the preset value; and when a manipulation signal of a control valve for another work implement provided in an MCV block (not shown) in which the boom control valve 15 is provided (for example, refer to an arm actuation control valve) is input. The controller 18 is connected to the first and second pressure sensors 16 and 17.

In the control method of the hydraulic apparatus for construction equipment according to the embodiment of the present invention,

the hydraulic apparatus for construction equipment includes: a variable cement hydraulic pump 11 (hereinafter, referred as a hydraulic pump) and a pilot pump 12; a boom cylinder 13 driven by a hydraulic fluid of the hydraulic pump 11; a boom manipulation lever 14 (RCV) outputting a manipulation signal corresponding to a manipulation amount; a boom control valve 15 (MCV) controlling a flow direction of the hydraulic fluid supplied to the boom cylinder 13 when the control valve is operated; a first pressure sensor 16 (16a and 16b) detecting a boom-down or boom-up pilot, pressure applied to the boom control valve 15; a second pressure sensor 17 detecting a pressure of the hydraulic fluid supplied to a small chamber or large chamber of the boom cylinder 13; and a controller 18 to which signals detected by the first and second pressure sensors 16 and 17 are input, wherein the control method includes:

in step S10, receiving an input of a boom-down manipulation signal by the detected signal of the first pressure sensor 16a;

in step S20, determining whether or not a hydraulic fluid pressure value supplied to the small chamber of the boom cylinder 13 is equal to or greater than a preset value by using the detected signal of the second pressure sensor 17;

in step S30, increasing a flow rate supplied from the hydraulic pump 11 to the small chamber of the boom cylinder 13 by a preset amount when signals detected by the first and second pressure sensors 16 and 17 designate an input of a boom-down manipulation signal, and the hydraulic fluid pressure value supplied to the small chamber of the boom cylinder 13 is equal to or greater than the preset value (refer to a jack-up ON operation condition);

in step S40, determining whether or not the boom-down manipulation signal is input, whether or not the hydraulic fluid pressure value supplied to the small chamber of the boom cylinder 13 is less than the preset value, and whether or not a manipulation signal of a control valve for another work implement provided in an MCV block (not shown) in which the boom control valve 15 is provided (for example, refer to an arm actuation control valve) is input; and

in step S50, changing the flow rate supplied from the hydraulic pump 11 to the small chamber of the boom cylinder 13 to an initial preset value when at least any on of following cases is satisfied: when the boom-down manipulation signal input by the detected signals of the first and second pressure sensors 16 and 17 is not input; when the hydraulic fluid pressure value supplied to the small chamber of the boom cylinder is less than the preset value; and when the manipulation signal of the control valve for another work implement provided in the MCV block (not shown) in which the boom control valve 15 is provided (for example, refer to an arm actuation control valve) is input.

The controller 18, in step S10, when a manipulation signal of a control valve for another work implement provided in an MCV block (not shown) different from the MCV block (not shown) in which the boom control valve 15 is provided (for example, a swing actuation control valve) is input, ignores the manipulation for another work implement, and determines the manipulation signal as the input signal of a boom-down manipulation.

According to the above configuration, as described in step S10, a spool of the boom control valve 15 is switched to a left direction in the figure since the pilot pressure by the manipulation of the boom manipulation lever 14 is applied to a right pressure receiving port of the spool of the boom control valve 15 in the figure.

The hydraulic fluid is supplied from the hydraulic pump 11 to the small chamber of the boom cylinder 13 by passing the boom control valve 15, and the hydraulic fluid discharged from the large chamber of the boom cylinder 13 is returned to a hydraulic fluid tank T by passing the boom control valve 15. Accordingly, a jack-up operation is performed by a retraction operation of the boom cylinder 13.

When the boom manipulation lever 14 is manipulated, the pilot pressure input to the boom control valve 15 is detected by the first pressure sensor 16a, and the detected signal is input to the controller 18.

Herein, even when the manipulation signal of the control valve for another work implement provided in the MCV block (not shown) different to the MCV block (not shown) which the boom control valve 15 is provided (for example, a swing actuation control valve) is input, the controller 18 ignores the manipulation signal for another work implement, and discriminate the boom-down manipulation as the input signal of a boom-down manipulation.

In other words, although a manipulation signal for performing a boom-down by switching the boom control valve 15 provided in an MCV block and by the manipulation of the boom manipulation lever 14, and a manipulation signal for swinging an upper frame by switching a swing actuation control valve (independently operated with the boom control valve 15) provided in another MCV block (block different from the MCV block in which the boom control valve 15 is provided) and by a manipulation of a swing manipulation lever (not shown) are input to the controller 18, the controller 18 ignores the manipulation signal for swinging the upper frame and discriminate the boom-down manipulation signal as the input of a boom-down manipulation.

As described in step S20, the pressure of the hydraulic fluid supplied from the hydraulic pump 11 to the small chamber of the boo cylinder 13 is detected by the second pressure sensor 17, and the detected signal is input to the controller 18.

Accordingly, the controller 18 determines whether or not the hydraulic fluid pressure value supplied to the small chamber of the boom cylinder 13 is equal to or greater than the preset value. When the hydraulic fluid pressure value supplied from the hydraulic pump 11 to the small chamber of the boom cylinder 13 is equal to or greater than the preset value, the controller 18 processes step “S30”. Alternatively, when the hydraulic fluid pressure value supplied from the hydraulic pump 11 to the small chamber of the boom cylinder 13 is less than the preset value, the controller 18 stops the process of the jack-up operation.

As described in step S30, when the pilot pressure value of the boom control valve 15 which is detected by the first pressure sensor 16a and input to the controller 18 is determined as the input of the boom-down manipulation signal, and the hydraulic fluid pressure value supplied to the small chamber of the boom cylinder 13, detected by the second pressure sensor 17 and input to the controller 18, is equal to or greater than the preset value, the controller 18 determines as an operation condition of jack-up ON.

Accordingly, the controller 18 adjusts a discharging flow rate of the hydraulic pump 11 to increase the flow rate supplied from the hydraulic pump 11 to the small chamber of the boom cylinder 13 by the preset amount by determining as the operation condition of jack-up ON.

Herein, since the configurator of increasing the discharging flow rate of the hydraulic pump 11 by adjusting the swivel angle of a swash plate of the hydraulic pump 11 in response to a control signal of the controller 18 is a technique used in the related art, detailed description thereof will be omitted.

As described above, when the jack-up operation is performed by a retraction operation of the boom cylinder 13, manipulability for the jack-up operation may be improved by increasing the flow rate supplied to the small chamber of the boom cylinder 13 by the preset amount.

As described in step S40, whether or not the boom-down manipulation signal is input, whether or not the hydraulic fluid pressure value supplied to the small chamber of the boom cylinder 13 is less than the preset value, and whether or not the manipulation signal of the control valve for another work implement provided in the MCV block (not shown) in which the boom control valve 15 (for example, arm actuation control valve) is provided is input are determined, and when at least any one of the above cases is satisfied, step “S50” is processed. When all of the above cases are not satisfied (refer to an operation condition of jack-up ON), step “S30” is processed.

As described in step S50, when at least any one of the following cases is satisfied: when the boom-down manipulation signal is not input; when the hydraulic fluid pressure value supplied to the small chamber of the boom cylinder 13 is less than the preset value; and when the manipulation signal of the control valve for the another work implement provided in the MCV block in which the boom control valve is provided is input, it is determined as an operation condition of jack-up OFF.

Accordingly, when the operation condition of jack-up OFF is determined by the detected signals of the first and second pressure sensors 16 and 17, the flow rate supplied from the hydraulic pump 11 to the small chamber of the boom cylinder 13 is changed to the initial preset value (default).

As described above, when the jack-up OFF operation is performed, and the work implement is descended by the retraction operation of the boom cylinder 13, fuel efficiency may be improved by minimizing the flow rate supplied to the small chamber of the boom cylinder 13 and thereby using the self-load.

Herein, the detailed description of the present invention is described with regard to the preferable embodiment of the present invention. However, a person skilled in the art may amend or modify the present invention within the spirit or scope in the following claims of the present invention.

### INDUSTRIAL APPLICABILITY

According to the present invention including the above described configuration, there is an effect on improving the operability of a jack-up operation by increasing a flow rate supplied from a hydraulic pump to a boom cylinder when performing the jack-up operation of an excavator.

1. A hydraulic apparatus for construction equipment, the hydraulic apparatus comprising:
a variable displacement hydraulic pump and a pilot pump;
a boom cylinder driven by a hydraulic fluid of the hydraulic pump;
a boom manipulation lever outputting a manipulation signal corresponding to a manipulation amount;
a boom control valve provided in a flow path between the hydraulic pump and the boom cylinder, and controlling a flow direction of the hydraulic fluid supplied to the boom cylinder when the control valve is operated;
a first pressure sensor detecting a boom-down or boom-up pilot pressure applied to the boom control valve;
a second pressure sensor detecting a pressure of the hydraulic fluid supplied from the hydraulic pump to a small chamber or large chamber of the boom cylinder; and
a controller increasing a flow rate supplied from the hydraulic pump to the small chamber of the boom cylinder by a preset amount when signals detected by the first and second pressure sensors designate an input of a boom-down manipulation signal, and a hydraulic fluid pressure value supplied to the small chamber of the boom cylinder is equal to or greater than a preset value.

2. A control method of a hydraulic apparatus for construction equipment, wherein the hydraulic apparatus includes: a variable displacement hydraulic pump; a boom cylinder driven by a hydraulic fluid of the hydraulic pump; a boom manipulation lever; a boom control valve controlling a flow direction of the hydraulic fluid supplied to the boom cylinder; a first pressure sensor detecting a boom-down or boom-up pilot pressure applied to the boom control valve; a second pressure sensor detecting a pressure of the hydraulic fluid supplied to the boom cylinder; and a controller to which signals detected by the first and second pressure sensors are input, the method comprising:
receiving an input of a boom-down manipulation signal by the detected signal of the first pressure sensor;
determining whether or not a hydraulic fluid pressure value supplied to the small chamber of the boom cylinder is equal to or greater than a preset value by using the detected signal of the second pressure sensor; and
increasing a flow rate supplied from the hydraulic pump to the small chamber of the boom cylinder by a preset amount when the detected signals of the first and second pressure sensors designate an input of the boom-down manipulation signal, and the hydraulic fluid pressure value supplied to the small chamber of the boom cylinder is equal to or greater than the preset value.

3. The apparatus of claim 1, wherein the controller changes the flow rate supplied from the hydraulic pump to the small chamber of the boom cylinder to an initial preset value when at least any one of following cases is satisfied: when the boom-down manipulation signal is not input; when the hydraulic fluid pressure value supplied to the small chamber of the boom cylinder is less than the preset value; and when a manipulation signal of a control valve for another work implement provided in an MCV block in which the boom control valve is provided is input.

4. The method of claim 2, wherein when a manipulation signal for a control valve of a work implement provided in another MCV block that is different from the MCV block in which the boom control valve is provided is input, the controller ignores the manipulation for the work implement, and determines the boom-down manipulation signal as the input signal of the boom-down manipulation.

5. The method of claim 2, further comprising:
determining whether or not the boom-down manipulation signal is input, whether or not the hydraulic fluid pressure value supplied to the small chamber of the boom cylinder is less than the preset value, and whether or not a manipulation signal of a control valve for another work implement provided in an MCV block in which the boom control valve is provided is input; and
changing the flow rate supplied from the hydraulic pump to the small chamber of the boom cylinder to an initial preset valve when at least any one of the following cases is satisfied:
when the boom-down manipulation signal by the detected signals of the first and second pressure sensors is not input;
when the hydraulic fluid pressure value supplied to the small chamber of the boom cylinder is less than the preset value; and
when the manipulation signal of the control valve for another work implement provided in the MCV block in which the boom control valve is provided is input.
